(19) United States
(12) Patent Application Publication
(10) Pub. No.: US 2008/0036611 A1
(43) Pub. Date: Feb. 14, 2008

(54) Methods and Apparatus for Controlling Pet Access

(76) Inventor: Daniel J. Noblitt, Scottsdale, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/738,257

(22) Filed: Apr. 20, 2007

Related U.S. Application Data
(60) Provisional application No. 60/745,185, filed on Apr. 20, 2006.

(51) Int. Cl. G08B 23/00; G08B 1/08

(52) U.S. Cl. 340/573.3; 340/3.1

(57) ABSTRACT

Methods and apparatus for controlling pet access according to various aspects of the present invention generally comprise a locking mechanism configured to selectively lock and unlock a pet door. A controller connected to the locking mechanism controls the locking mechanism in response to a control signal. A wireless receiver connected to the controller conveys the control signal to the controller.

### CROSS-REFERENCE TO RELATED APPLICATION

This application claims the benefit of U.S. Provisional Patent Application No. 60/745,185, filed Apr. 20, 2006, and incorporates the disclosure of that application by reference.

### BACKGROUND OF INVENTION

Pets enrich the lives of families and individuals around the world, providing companionship, love, protection, and entertainment. For many pet owners, nothing is more important than the safety, comfort, and well-being of their pets. For many, pets occupy a position comparable to children.

Unlike children, however, pets have specific needs that are not shared with their owners. Common household pets, such as dogs and cats, may live largely indoors, but need to be let outside to relieve themselves, exercise, or just to avoid boredom. Busy owners, however, may not be able to let the pets in and out conveniently, due to being at work or traveling.

Simple care for such pet needs is often resolved by family members, neighbors, or hired help. These solutions, however, rely on humans, which are prone to forgetting about their obligations, leaving the pets stranded inside or outside. Pet doors, on the other hand, allow the pets to let themselves in and out, but present a potential security risk. Pet doors also let the pets in and out regardless of the owner's wishes. For example, if work is being done in the yard in the afternoon, the owner may wish to allow the pets to access the yard in the morning but keep them in the house in the afternoon to be sure they do not bother or harm the workers or possibly escape through an open gate in the yard. To meet this need, the owner again requires human on-site assistance.

### SUMMARY OF THE INVENTION

In various representative aspects, and apparatus for controlling pet access according to various aspects of the present invention generally comprise a locking mechanism configured to selectively lock and unlock a pet door. A controller connected to the locking mechanism controls the locking mechanism in response to a control signal. A wireless receiver connected to the controller conveys the control signal to the controller.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 is a block diagram of a pet door system according to various aspects of the present invention.

FIG. 2 is a cross-section view of a wireless pet door control system.

FIG. 3 is a flow chart of a process for allowing pets egress.

FIG. 4 is a flow chart of a process for allowing pets ingress.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, a system according to various aspects of the present invention may employ transmitters, receivers, doors, and the like, which may carry out a variety of functions. In addition, the present invention may be practiced in conjunction with any number of access systems and animal control systems, and the system described is merely one exemplary application for the invention. Further, a system according to the present invention may employ any number of conventional techniques for wireless communications, door control, and the like.

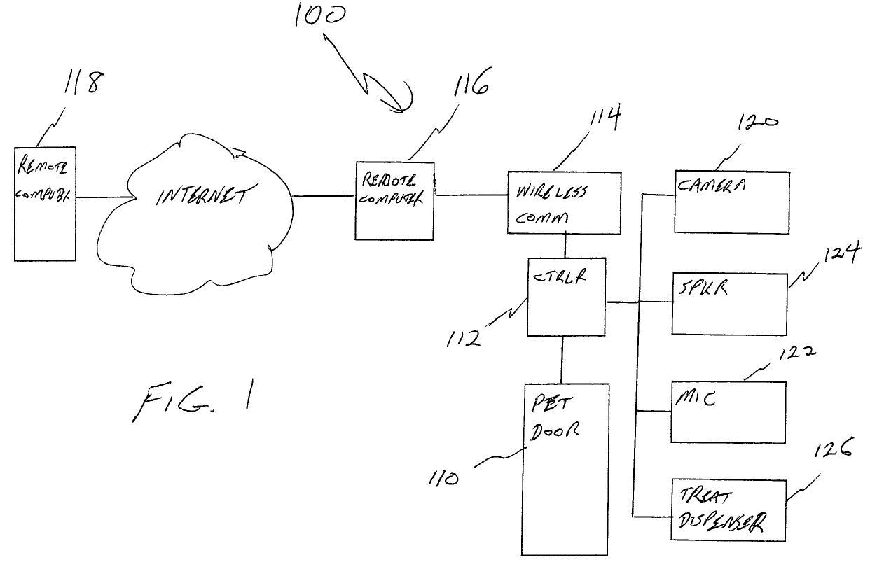

Methods and apparatus for controlling pet access may operate in conjunction with a pet access control system 100, for example to control a pet door. Referring now to FIG. 1, the pet access control system 100 may comprise a pet door 110, a controller 112, and a wireless transceiver 114. The controller 112 controls the movement of the door 110, for example via a locking mechanism responsive to the controller 112 and connected to the door 110. The controller 112 receives signals from the wireless transceiver 114 to control the door 110.

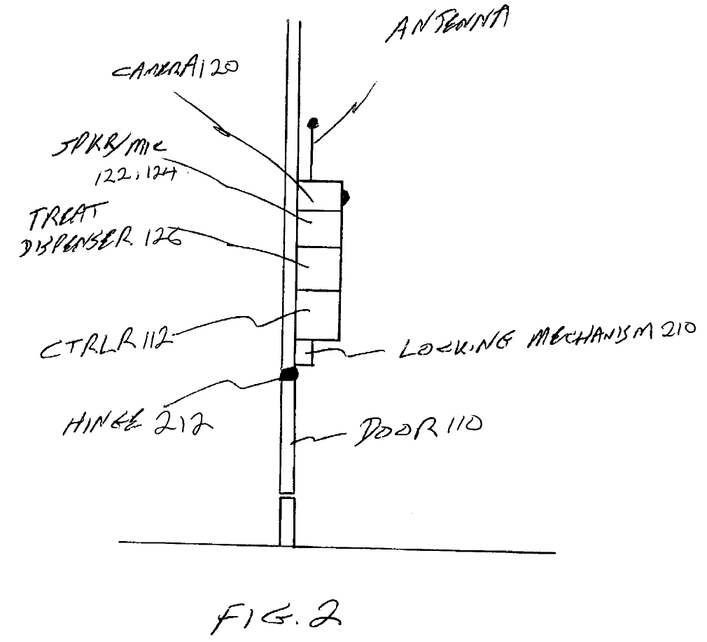

More particularly, referring to FIG. 2, the locking mechanism 210 controls movement of the door 110, and is controlled by the controller 112. The door 110 may comprise any suitable system for selectively facilitating access to a structure, such as a swinging rigid pet door 110, a rolling door, or a one- or two-way door. In the present embodiment, the door 110 comprises a conventional pet door comprising a rigid door connected to a structure defining a hole, such as a conventional door for human passage or a wall. The door 110 is pivotably connected, such as by a hinge 212 connected to the top of the door 110 and the top edge of the hole. The hinge allows the door 110 to swing, for example in response to force applied by a pet. The door 110, however, may comprise any suitable system for facilitating access to the structure.

The locking mechanism 210 controls whether the door 110 may move. The locking mechanism 210 may comprise any suitable system for selectively inhibiting movement of the door 110. For example, the hinge 212 and/or door 110 may have a locked state and an unlocked state, such that the door 110 moves or may be moved in the unlocked state, and the door 110 is immobilized in the locked state. The transition between the locked state and the unlocked state may occur in response to a signal, such as an electrical signal, mechanical force, or other signal. For example, in the present embodiment, the hinge 212 includes an actuator responsive to the controller 112 to facilitate locking the hinge 212 in position to prevent rotation and inhibit movement of the door 110. The actuator may also respond to the controller 112 to unlock the hinge 212 to permit the door 110 to swing. Alternatively, the lock may be separate from the hinge 212, such as a bar, clamp, bolt, or other mechanism that may selectively inhibit movement of the door 110. In another embodiment, the locking mechanism 210 may be incorporated into another system, such as a motor for moving the door 110.

The controller 112 controls the locking mechanism 210 to control whether the locking mechanism 210 is in the locked or unlock state. The controller 112 may comprise any appropriate system for controlling the locking mechanism 210. For example, the controller 112 may comprise a conventional, processor, logic circuit, analog circuit, or other control system connected to the locking mechanism 210. In the present embodiment, the controller 112 includes a microprocessor connected to the locking mechanism 210 to provide control Signals to the locking mechanism 210. The controller 112 is may also be connected to the wireless transceiver 114 to receive instructions. Alternatively, the controller 112 may be self-contained and operate without instructions from a wireless transceiver 114 or other source, such as in conjunction with a program. The program may operate the locking mechanism 210 in any suitable manner, such as a time-based program to lock and unlock the locking mechanism 210 at selected times or the like.

In the present, embodiment, the controller 112 is connected to the wireless transceiver 114 to receive signals for controlling the locking mechanism 210. The wireless transceiver 114 is configured to receive signals via a wireless connection and provide corresponding signals to the controller 112. The wireless transceiver 114 may comprise any suitable system for transmitting and/or receiving wireless signals, such as a cellular receiver, an IEEE 802.11 compliant receiver, an infrared receiver, or the like.

The wireless transceiver 114 may be controlled in any suitable manner. For example, the wireless transceiver 114 may comprise an IEEE 802.11 compliant transceiver configured to transmit and receive signals to communicate with other wireless systems, such as a wireless router. Referring again to FIG. 1, in the present embodiment, the pet access control system 100 may operate in conjunction with a software program operating on a remote computer 116, such as a conventional personal computer, which controls the controller 112 via a suitable wireless connection, such as a local wireless network. The user may interact with the software via a graphical user interface (GUI), which presents options for controlling the pet access control system 100. For example, the GUI may comprise a website interface that is run by the remote computer 116 and may be accessed by other computers 118. A user may use the other computer 118 to access the remote computer 116, for example via the Internet, and select operations for the pet access control system 100, such as locking and unlocking the locking mechanism 210. The remote computer 116 provides signals to the wireless transceiver 114, for example via the router, which are used to control the locking mechanism 210 via the controller 112.

Access to the controller 112 via the wireless transceiver 114 may performed in any suitable manner. For example, the controller 112 may include a computer that may be controlled from other computers 118 without connecting to the remote computer 116. In one embodiment, the functions of the remote computer 116 may be integrated into the controller 112.

The pet access control system 100 may also include any other suitable systems associated with pets, pet access, pet monitoring, or other functions. For example, the pet access control system 100 may include a camera 120 connected directly or indirectly to the wireless transceiver 114. In the present embodiment, the camera 120 is configured to monitor one or both sides of the pet door 110, such as to monitor the status of the pet. The camera 120 may monitor an area for a pet wishing to pass through. The camera 120 may be connected to the wireless transceiver 114 via the controller 112, such as to send image data to the remote computer 116 and/or other computers 118 via the wireless transceiver 114 so that a user may monitor an area. The camera 120 may also receive signals from the controller 112, for example to activate and deactivate the camera 120, zoom, pan, or otherwise operate the camera 120.

The pet access control system may also include an audio system, such as a microphone 122 and/or a speaker 124. The audio system may be connected to the controller 112, for example to communicate with the user via the remote computer 116 and the wireless transceiver 114. The audio system may perform any suitable functions. For example, signals may be transmitted from the user to the speaker 124, such as to talk to pets or provide audible signals from the user or the controller 112. In addition, the microphone 122 may transmit signals corresponding to sounds to the controller 112 and/or user, such as to monitor a pet's condition.

The pet access control system may also include a treat dispenser 126, for example to provide training incentives and/or remotely feed pets. The treat dispenser 126 may comprise any suitable system, such as a hopper for containing treats or other food and a dispenser for releasing the treats for consumption. The treat dispenser 126 is suitably connected to the controller 112 to control the treat dispenser 126, for example in response to a program for regular feeding of the pet and/or signals from the user via the remote computer and/or the wireless transceiver 114.

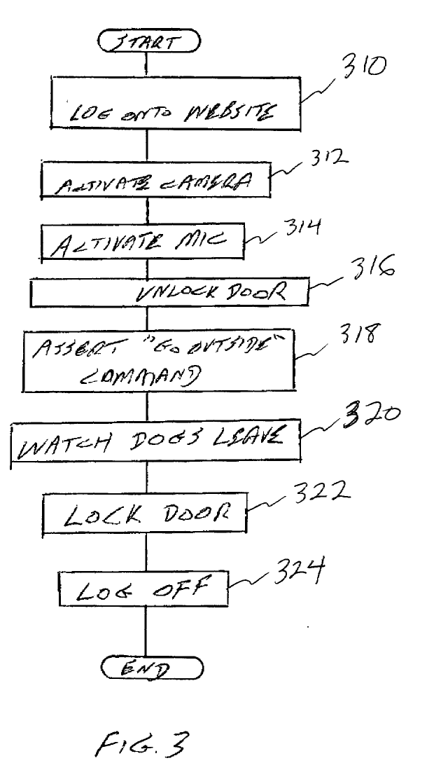

In operation, the pet access door 110 may be in a locked state with the pet inside a room on one side of the door 110. Referring to FIG. 3, the user may access the pet access control system 100 remotely, for example by accessing an Internet website via a web browser (310). The user may interact with the pet access control system 100 via the remote computer 116 or other computer 118 in any suitable manner. For example, the user may activate the camera 120 (312) and the microphone 122 (314) to monitor the pet's condition, such as to see whether the pet wishes to be let outside or is lonely. The user may also operate the speaker 124, such as to provide commands to the pet or speak to the pet. In addition, the user may activate the treat dispenser 126, such as to remotely feed the pet, reward behavior, make the pet happy, or the like. The various functions may be integrated into one or more pages of the website, such as by providing buttons to activate the microphone 122, camera 120, and treat dispenser 126, a viewing area to display the transmission from the camera 120, and status displays, such as to show the state of the locking mechanism 210, fullness of the treat dispenser 126, last time and date the pets were allowed outside and for how long, and the like.

To allow the pet outside, fee user may change the state of the locking mechanism 210 to an unlocked state (316) via the remote computer 116, such as by pressing a corresponding web interface button. The instruction may transmitted to the controller 112, for example from the remote computer 116 via a wireless network and the wireless transceiver 114. The user and/or controller 112 may also encourage the pet to exit via the door 110 (318), for example by providing a verbal command, ringing a bell or emitting a corresponding sound via the speaker 124, or the like. The user may also confirm the exit of the pet via the camera 120 (320). When the pet exits, the controller 112 and/or the user may leave the door 110 unlocked or change locking mechanism 210 to a locked state (322). If the pet is likely to be outside for a significant amount of time, the user may wish to leave the website and log off (324).

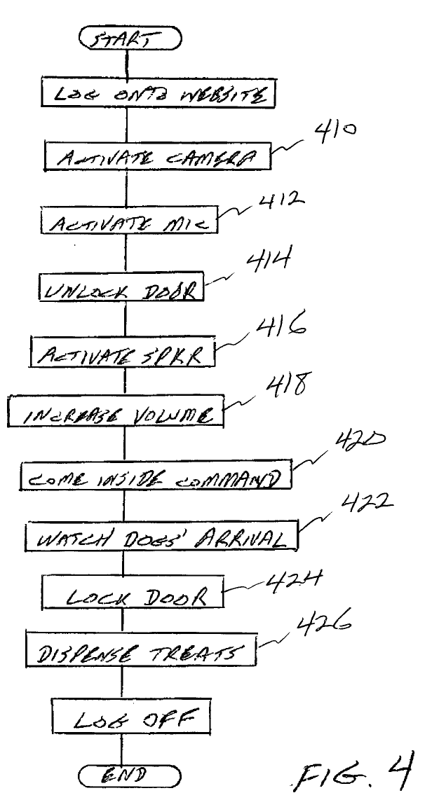

Referring to FIG. 4, while the pet is outside, the user may monitor the pet, for example via an outdoor camera 120 (410) and microphone 122 (412). When the pet returns, the door 110, if locked, may be unlocked to permit the pet to enter (414). Alternatively, the door 110 may remain unlocked for a selected period of time. The controller 112 and/or the user may also generate a signal, such as sounding a bell or buzzer or a verbal command, to signal the pet to return and enter through the door 110. For example, the user may activate the speaker 124 (416), adjust the volume (418), and command the pet to go inside (420).

When the pet enters, the user and/or controller 112 may monitor the pet's return (422) and lock the door 110 (424). The user and/or controller 112 may also provide any appropriate feedback to the pet, such as verbal rewards or a treat from the treat dispenser 126 (426).

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A control system for controlling a pet door via a remote computer, comprising:
a locking mechanism configured to selectively lock and unlock the pet door;
a controller connected to the locking mechanism and configured to control the locking mechanism in response to a control signal; and
a wireless receiver connected to the controller and configured to convey the control signal from the remote computer to the controller.

2. A control system according to claim 1, wherein the wireless receiver comprises an IEEE 802.11 compliant receiver.

3. A control system according to claim 1, further comprising a camera connected to the wireless receiver and configured to generate image data.

4. A control system according to claim 1, further comprising:
a microphone connected to the controller and configured to generate audio data corresponding to sounds; and
a speaker connected to the controller and configured to generate audible noise in response to audio signals from the controller;
wherein the controller is configured to:
transmit the audio data generated by the microphone via the wireless networking component; and
provide the audio signals to the speaker.

5. A control system according to claim 1, wherein:
the wireless pet door control system further comprises a food dispenser connected to the controller; and
the controller is configured to activate the food dispenser to dispense food in response to a food signal received via the wireless networking component.

6. A control system, according to claim 1, wherein the controller is configured to respond to signals received via a website.

7. A system for controlling pet access to a structure via a remote computer, a global communications network, and a wireless network unit, comprising:
a pet door connected to the structure;
a wireless pet door control system, comprising:
a wireless networking component configured to communicate with the remote computer via the wireless network unit and the global communications network;
a controller responsive to the wireless networking component and configured to generate control signals in response to instructions received from the remote computer via the wireless networking component; and
a locking mechanism responsive to the controller, wherein the locking mechanism is configured to engage the structure and to selectively lock and unlock foe pet door is response to the control signals.

8. A system for controlling pet access according to claim 7, wherein the wireless networking component comprises an IEEE 802.11 compliant transceiver.

9. A system for controlling pet access according to claim 7, wherein the wireless pet door control system further comprises a camera connected to the wireless networking component and configured to generate image data corresponding to an area on at least one side of the structure.

10. A system for controlling pet access according to claim 7, wherein the wireless pet door control system further comprises:
a microphone connected to the controller and configured to generate audio data corresponding to sounds in an area on at least one side of the structure; and
a speaker connected to the controller and configured to generate audible noise in response to audio signals from the controller;
wherein the controller is configured to:
transmit the audio data generated by the microphone to the remote computer via the wireless networking component; and
transmit the audio signals received from the remote computer via the wireless networking component to the speaker.

11. A system for controlling pet access according to claim 7, wherein:
the wireless pet door control system further comprises a food dispenser connected to the controller; and
the controller is configured to activate the food dispenser to dispense food in response to a food signal received from the remote computer via the wireless networking component.

12. A system for controlling pet access according to claim 7, wherein the wireless pet door control system is configured to respond to signals received via a website.

13. A method for controlling a pet door providing access to a structure from a remote computer via a global communication network, comprising:
transmitting from the remote computer a remote signal to lock or unlock the pet door via the global communication network;
receiving a wireless signal by a wireless networking component in response to the remote signal;
transmitting a control signal to a locking mechanism configured to selectively lock and unlock the pet door in response to the wireless signal; and
at least one of locking and unlocking the pet door in response to the control signal.

14. A method for controlling a pet door according to claim 13, wherein the wireless networking component comprises an IEEE 802.11 compliant transceiver.

15. A method for controlling a pet door according to claim 13, further comprising transmitting image data from a camera to the remote computer via the wireless networking component.

16. A method for controlling a pet door according to claim 13, further comprising:
generating audio data corresponding to sounds in an area; and
generate audible noise in response to audio signals from the controller;
transmitting the audio data to the remote computer via the wireless networking component; and
transmitting the audio signals from the remote computer via the wireless networking component to the speaker.

17. A method for controlling a pet door according to claim 13, further comprising dispensing food in response to a food signal received from the remote computer via the wireless networking component.

18. A method for controlling a pet door according to claim 13, wherein the wireless pet door control system is configured to respond to signals received via a website.
